(19) United States
(12) Patent Application Publication
(10) Pub. No.: US 2009/0038196 A1
(43) Pub. Date: Feb. 12, 2009

(54) ELASTIC BAND WITH WRITE/ERASE LABEL

(75) Inventors: Lauren Grassia, East Northport, NY (US); Denise Ceron, Syosset, NY (US); Kimberly M. Carr, Elmont, NY (US)

Correspondence Address: DORSEY & WHITNEY LLP;INTELLECTUAL PROPERTY DEPARTMENT, 250 PARK AVENUE, NEW YORK, NY, 10177, US

(73) Assignee: ESSELTE CORPORATION, Melville, NY (US)

(21) Appl. No.: 12/188,651

(22) Filed: Aug. 8, 2008

Related U.S. Application Data
(60) Provisional application No. 60/955,322, filed on Aug. 10, 2007.

(51) Int. Cl. G09F 3/14; B42F 3/00

(52) U.S. Cl. 40/665; 402/8

(57) ABSTRACT

An organizational device that includes an elastic band, and a label portion mounted on the band is described. The label portion includes a writable member that includes a writing surface of oriented polypropylene for writing and erasing thereon, and a mounting portion affixing the writable member to the band. The elastic band and the label portion form a closed loop.

### CROSS REFERENCE TO RELATED APPLICATIONS

This application claims the benefit of priority from U.S. Patent Application No. 60/955,322, filed Aug. 10, 2007, the entire disclosure of which is incorporated herein by reference.

### FIELD OF INVENTION

The present invention relates to an organizational device for arranging various articles, such as index cards. More particularly, the invention relates to a device that includes an elastic band and a label portion mounted on the band.

### BACKGROUND OF THE INVENTION

Various organizational tools for securing and organizing school or office supplies are known. Due to its ability to return to its original shape after deformation, many of these tools incorporate an elastic band. Often, piles of documents and files need to be labeled and quickly identified for easy retrieval. Traditional elastic bands, however, do not include a section on the band that can be labeled. Thus, a user must typically attach a separate piece of paper or a sticker marked with labeling information.

While many have attempted to solve the above-described problem, the size, configuration, and/or attachment mechanisms can make the elastic band awkward to use and hold. For example, integrating a label section on a traditional rubber band can make the rubber band bulky or heavy and inconvenient to use.

U.S. Pat. No. 1,960,690 discloses an elastic retaining band for holding a bundle of documents. An indicating card is inserted in slots in the band. U.S. Pat. No. 5,584,103 discloses a plastic banding strap for use in securing items in a rolled position. At one end of the strap, a surface is provided for writing or placing an indicia thereon. Writing directly on the surface allows for permanent type marking. U.S. Pat. No. 7,096,544 discloses an organizational device for the wrapping of articles. The device includes an expandable loop fabric strap and a business card size plastic sleeve with a transparent front. The strap may be decorated with writing or company logos. U.S. Pat. No. 7,125,049 discloses an elastic band for use as a bookmark, the band including a slider that can receive a sticker image thereon. Other references describe bands having an encoded pattern or indicia thereon, a metal plate mounted thereto, or a label sewn thereon.

U.S. Publication No. 2006/0207132 discloses a beverage identifier having an elastic band for elastically engaging an outer surface of an individual beverage container and a tag hanging from the elastic band. The tag surface can be formed of a material that is capable of being marked and subsequently erased.

There is a need for an organizational device that secures items and also facilitates the simple marking of these items with labeling information.

### SUMMARY OF THE INVENTION

The present invention is directed to an organizational device. A preferred embodiment of the device includes an elastic band and a label portion mounted on the band. The label portion includes a writable member that includes a writing surface, such as oriented polypropylene for writing and erasing thereon, and a mounting portion affixing the writable member to the band. The elastic band and the label portion form a closed loop.

Generally, the writable member can include a base layer that is laminated with the oriented polypropylene. Preferably, the base layer comprises a paper layer.

In one embodiment, the label portion includes a retaining frame connected with the mounting portion and attached with the writable member. The retaining frame has an open central portion for framing the writable member to leave a portion thereof exposed for writing. In this same embodiment, the mounting portion preferably extends through the elastic band from the frame portion on an outer side of the band to an inner side of the band opposite from the outer side at at least two locations that are circumferentially displaced on opposite sides of the label.

The frame portion preferably extends around the elastic band such that an inner section of the frame portion is disposed on the inner side of the band. The mounting portion usually includes a weld at each of the at least two locations extending from the inner section, through the elastic band, and to the frame portion on the outer side. The frame portion is preferably wrapped around the elastic band on each axial side of the band from the outer side to the inner side.

The label portion can include a semi-rigid stiffening member disposed beneath the writable member and configured to provide writing support thereto, and the welds extend through the stiffening member.

Advantageously, the writing surface is capable of being marked on by one or more water soluble markers, dry-erase markers, permanent markers, and ballpoint pens, and erased by wiping with a cloth, preferably without requiring wetting. The elastic band favorably includes a woven fabric configured to limit the elastic extension of the band. The elastic band may include elastic members extending through or interwoven in the fabric. The band preferably has a circumference and elasticity selected to hold a stack of index cards.

The retaining frame is preferably affixed to the band by welds extending through the elastic band from the frame portion on an outer side of the band to an inner side of the band opposite from the outer side at at least two locations that are circumferentially displaced on opposite sides of the writable member. The elastic band and the label portion form a closed loop.

Welds may surround the circumference of the retaining frame, and the welds that affix the retaining frame to the band typically extend along the axial side of the retaining frame.

Preferably, the writable member includes a base layer that is laminated with oriented polypropylene, and the label portion includes a semi-rigid stiffening member disposed beneath the writable member and configured to provide writing support thereto. The welds can extend through the stiffening member.

### BRIEF DESCRIPTION OF THE DRAWINGS

FIG. 1 is a front perspective view of a preferred embodiment of a organizational device constructed according to the present invention;

FIG. 2 is a cut away, back perspective view thereof;

FIG. 3 is a cross sectional view thereof taken along plane III-III shown in FIG. 4;

FIG. 4 is a circumferential cross sectional view thereof taken along plane IV-IV; and

FIG. 5 is a front perspective view thereof around a stack of index cards with a label marking thereon.

### DETAILED DESCRIPTION OF THE PREFERRED EMBODIMENTS

The present invention provides a flexible means of keeping organized documents stacked and organized in an easily portable manner especially when transferring these documents to and from home, office, school, or a client's premises. The present invention enhances one's organization efficiency by labeling files, separating documents, transferring files and documents in a secure manner, and providing a secure way to maintain files and documents. The present invention is more reliable and professional than using rubber bands, and provides easy access to a variety of articles contained within the elastic band, including files, documents, folders, binders, and books.

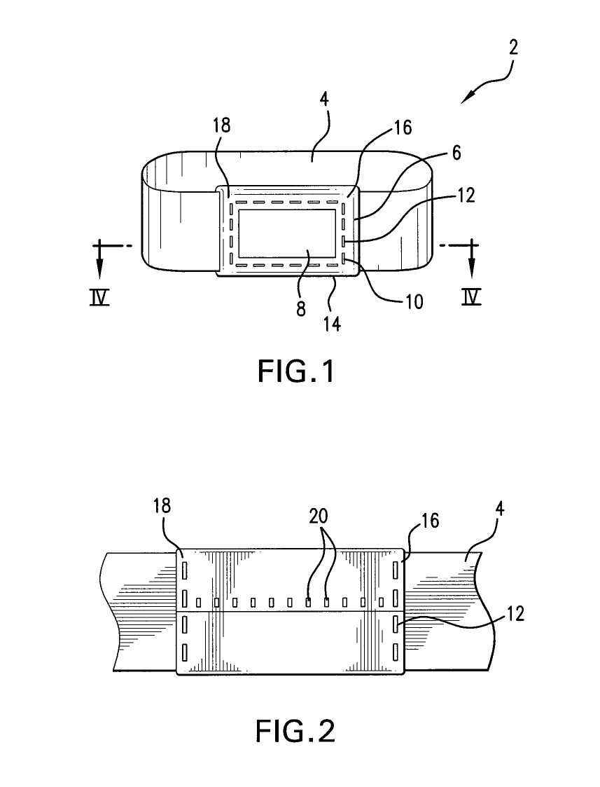

FIG. 1 illustrates a preferred embodiment of the organizational device 2. The device 2 includes an elastic band 4, and a label portion 6 mounted on the band 4. The label portion 6 includes both a writable member 8 and a mounting portion 10 affixing the writable member 8 to the band 4. The elastic band 4 and the label portion 6 form a closed loop. In the embodiment shown, the elastic band 4 is formed or sewn into a closed loop and the label portion 6 is mounted thereto. In FIG. 1, the mounting portion 10 includes a weld or welds 12, although alternate embodiments can use other suitable mounting portions.

The elastic band 4 is typically formed of elastic materials such as natural rubber, synthetic polyisoprene, an ethylene propylene rubber such as ethylene propylene diene monomer, silicone compounds, or a mixture thereof. Typically, a plain elastic band, however, wrinkles or twists the item it secures, resulting in damage to the item. The elastic band can also roll over the items it secures, resulting in the items scattering or becoming disorganized. Thus, in a preferred embodiment, the elastic band 4 includes stretchable material incorporating elastomeric fibers. In another preferred embodiment, the elastic band includes a woven fabric configured to limit the elastic extension of the band.

The elastic band 4 can include woven or braided fabric containing elastic fibers. The elastic band 4 preferably includes cloth material that is weaved with thin elastic bands throughout. The fabric material used in the elastic band 4 can be selected from, for example, silk, cotton, synthetic fiber polymers and blends thereof. Synthetic fibers can be based upon natural organic polymers, such as rayon (regenerated cellulose), acetate (partially acetylated cellulose derivative), triacetate (fully acetylated cellulose derivative), azlon (regenerated protein), and the like. It is preferred, however, that the synthetic fiber be based upon synthetic organic polymers, such as acrylic (polyacrylonitrile), aramid (aromatic polyamides), nylon (aliphatic polyamides), olefin (polyolefins), polyester (polyesters of an aromatic dicarboxylic acid and a dihydric alcohol), spandex (segmented polyurethane), vinyon (polyvinyl chloride), and the like.

The fabric limits stretch and also provides a lower friction surface than exposed rubber so the elastic band 4 is easier to slide on and off any articles that it secures. The interwoven fabric makes the elastic band 4 much more resilient than just the elastic itself. The fabric makes the elastic band 4 harder to snap or break, while also providing a ready surface that can be stylized. The fabric construction of the elastic band 4 provides a medium for bearing indicia such as organizational names/logos for corporations, firms, teams, schools, or colleges. The elastic band 4 may also be used to gift wrap certain items, with the fabric in various colors and/or decorated with colorful designs and patterns.

The writable member 8 includes a writing surface of oriented polypropylene for writing and erasing thereon. The writing surface is advantageously capable of being marked on by one or more water soluble markers, dry-erase markers, permanent markers, and ballpoint pens, and erased by wiping with a cloth. This allows identifying changes to be repeatedly changed or altered by the user.

The writable member 8 typically includes a base layer that is laminated with the oriented polypropylene. The base layer may include a plastic, cardboard, or paper layer.

It has been found that oriented polypropylene (OPP) provides a surface adapted for writing thereon and for dry erasure of the writing for reuse. OPP is a flexible material derived from melting and orienting (stretching) a polymer called polypropylene. It is a raw material that is an oil based product. It is inert and unaffected by most chemical agents occurring in everyday life. OPP films offer superior printability, machinability, and graphic appeal and provide cost savings over other flexible packaging materials.

Other polymers suitable for use in the present invention for a dry erase surface include polyvinyl chloride (PVC); polyfluorocarbon polymers, such as polytetrafluoroethylene, fluoroethylene propylene copolymer, fluoroethylene alkyl vinyl ether copolymer, and ethylenetetrafluoroethylene copolymer cellulose acetate propionate; and cellulose acetate based polymers, such as cellulose acetate propionate.

The label portion 6 usually contains a retaining frame 14 connected with the mounting portion 10 and attached with the writable member 8. The retaining frame 14 surrounds the writable member 8 and has an open central portion for framing the writable member 8 to leave a portion thereof exposed for writing. The retaining frame 14 also provides the label portion 6 with a more attractive appearance. Although FIGS. 1-4 illustrate the retaining frame 14 as having a rectangular shape, it should be understood that the frame 14 may be any shape suitable for the purposes described herein. For instance, the edges of the frame 14 may be rounded.

The mounting portion 10 affixes the writable member 8 to the elastic band 4. The writable member 8 may be affixed to the elastic band 4, preferably by welding, such as ultrasonic welding, but alternatively in any number of ways, including, but not limited to the use of sewing, adhesive, or heat sealing.

As can be seen in FIGS. 1 and 2, the weld 12 advantageously extends through the elastic band 4 from the frame portion 14 on an outer side of the band 4 to an inner side of the band 4 opposite from the outer side at at least two locations 16 and 18 that are circumferentially displaced on opposite sides of the label 6. FIG. 2 illustrates the side of the frame portion 14 that is on the inner side of the elastic band 4, while FIG. 1 illustrates the side of the frame portion 14 that is on the outer side of the band 4.

As can be seen in FIGS. 1 and 2, welds can surround the periphery of the retaining frame 14, but not all the welds necessarily extend through the outer side of the elastic band 4 to the inner side of the elastic band 4. Preferably, only the welds that extend axially go through the elastic band 4 on the outer side to the inner side, for example, weld 12. In FIG. 2, the frame portion 14 extends around the elastic band 4 such that an inner section of the frame portion 14 is disposed on the inner side of the elastic band 4. The frame portion 14 is welded together with welds 20.

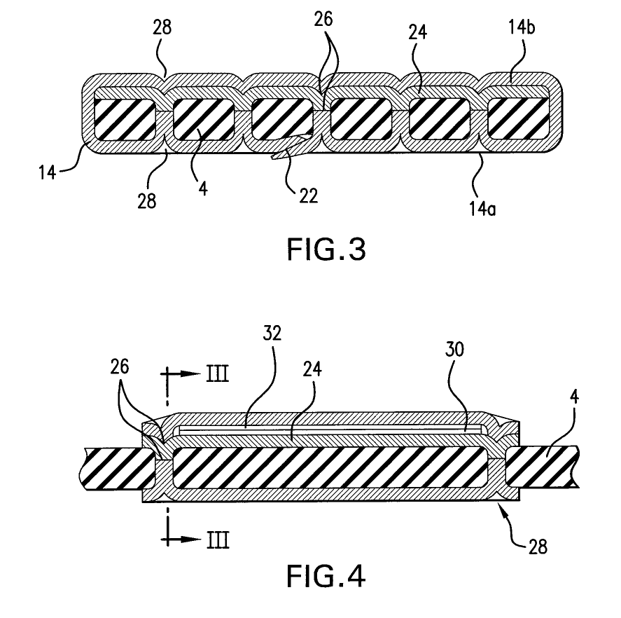

Referring to FIG. 3, the mounting portion 10 includes a weld 22 at each of the at least two locations 16 and 18 extending from the inner section 14a, through the elastic band 4, and to the frame portion 14b on the outer side. The welds should affix the writable member 8 securely to the elastic band 4 in such a way that the writable member 8 does not slide across the band 4 or fold.

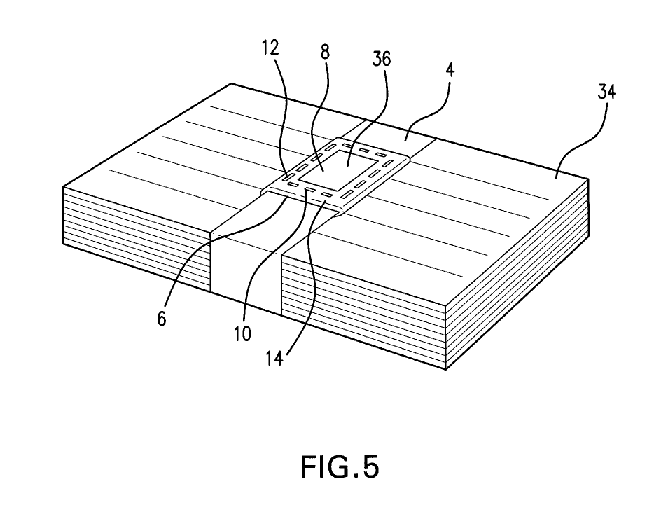

In FIGS. 3 and 4, the label portion 6 includes a semi-rigid stiffening member 24 disposed beneath the writable member 8 and configured to provide writing support thereto. The weld 22 extends through the stiffening member 24. The welds 26 are made in a welding operation that can weld several layers of materials together, including layers of the frame portion 14 and stiffening member 24. Indentations 28 are made from the pressure applied by the welding tool. In FIG. 4, the base layer 30 is shown having a lamination 32 on its top surface. Preferably, the writable member 8 and the stiffening member 24 are attached using an adhesive.

During the welding process, the material of the retaining frame 14 is preferably forced through and penetrates the different layers. This material can be forced through at separate points of the retaining frame 14 to be welded to material on the other side of the band, or to the band itself. The material that is forced through can penetrate or melt the different layers, such as the fabric of the elastic band 4. A welding apparatus shaped as a comb or roller with several teeth on one or both sides, for instance can be used to weld the layers together. In a preferred embodiment, the frame portion 14 and stiffening member 24 are made of polypropylene.

Referring to FIG. 5, while the elastic band 4 may have a circumference and elasticity to hold a wide variety of materials, in a preferred embodiment the band 4 is configured for holding a stack of index cards 34. The elastic band 4 usually measures about 3 to 6 inches in length in its relaxed state, and stretches to about 6 to 12 inches. The typical width of the elastic band 4 is about 1 to 2 inches, while its thickness is about 1/16 to ¼ of an inch. The label portion 8 generally measures about 1.5 to 3 inches in length, about 1 to 2 inches in width, and about 1/16 to ¼ inch in thickness. The circumference of the elastic band with or without the label portion 6 ranges from about 3 to 8 inches. In an exemplary embodiment, the measurements of the elastic band 4 are: about 4.5 inches in length in its relaxed state, about 10 inches in its stretched state, about 1.25 inches in width, and about 3/16 inch in thickness. The circumference of the band 4 without the label portion 6 is preferably about 4.25 inches, and with the label portion 6 is about 6 inches. In a most preferred embodiment, the measurements of the label portion 8 are: about 2 inches in length, about 1.25 inches in width, and about ⅛ of an inch thick. The size of the index cards 34 is not critical and the elastic band 4 can go around index cards measuring, for instance 3×5, 4×6, and 5×8 inches. Typically, the elastic band 4 stretches to hold 15 to 100 index cards. The writable member 8 in FIG. 5 includes a marking 36 indicating that the index cards 34 relate to math.

The present invention may be packaged in a variety of visually appealing configurations. Two or more of the organizational devices may be mounted on a hanging holder for hanging on a store display. A combination product of the device and index cards may also be sold together.

Although preferred embodiments of the invention have been described in the foregoing description, it will be understood that the invention is not limited to the specific embodiments disclosed herein but is capable of numerous modifications by one of ordinary skill in the art. It will be understood that the materials and methods used can be slightly different or modified from the descriptions herein without departing from the materials and methods disclosed and taught by the present invention.

What is claimed is:

1. An organizational device, comprising:
an elastic band; and
a label portion mounted on the band comprising:
a writable member that includes a writing surface of oriented polypropylene for writing and erasing thereon, and
a mounting portion affixing the writable member to the band;
wherein the elastic band and the label portion form a closed loop.

2. The organizational device of claim 1, wherein the writable member includes a base layer that is laminated with the oriented polypropylene.

3. The organizational device of claim 1, wherein the label portion comprises a retaining frame connected with the mounting portion and attached with the writable member, the retaining frame having an open central portion for framing the writable member to leave a portion thereof exposed for writing.

4. The organizational device of claim 3, wherein the mounting portion extends through the elastic band from the frame portion on an outer side of the band to an inner side of the band opposite from the outer side at at least two locations that are circumferentially displaced on opposite sides of the label.

5. The organizational device of claim 4, wherein the frame portion extends around the elastic band such that an inner section of the frame portion is disposed on the inner side of the band, and the mounting portion comprises a weld at each of the at least two locations extending from the inner section, through the elastic band, and to the frame portion on the outer side.

6. The organizational device of claim 5, wherein the frame portion is wrapped around the elastic band on each axial side of the band from the outer side to the inner side.

7. The organizational device of claim 5, wherein the base layer comprises a paper layer.

8. The organizational device of claim 7, wherein the label portion comprises a semi-rigid stiffening member disposed beneath the writable member and configured to provide writing support thereto, and the welds extend through the stiffening member.

9. The organizational device of claim 1, wherein the writing surface is capable of being marked on by one or more water soluble markers, dry-erase markers, permanent markers, and ballpoint pens, and erased by wiping with a cloth.

10. The organizational device of claim 1, wherein the elastic band comprises a woven fabric configured to limit the elastic extension of the band.

11. The organizational device of claim 10, wherein the elastic band comprises elastic members extending through the fabric.

12. The organizational device of claim 1, wherein the band has a circumference and elasticity selected to hold a stack of index cards.

13. An organizational device, comprising:
an elastic band; and
a label portion mounted on the band comprising:
a writable member that includes a writing surface configured for writing and erasing thereon,
a retaining frame connected with the mounting portion and attached with the writable member, the retaining frame having an open central portion for framing the writable member to leave a portion thereof exposed for the writing and erasing, the retaining frame being affixed to the band by welds extending through the elastic band from the frame portion on an outer side of the band to an inner side of the band opposite from the outer side at at least two locations that are circumferentially displaced on opposite sides of the writable member;
wherein the elastic band and the label portion form a closed loop.

14. The organizational device of claim 13, wherein the elastic band comprises a woven fabric configured to limit the elastic extension of the band.

15. The organizational device of claim 14, wherein the elastic band comprises elastic members extending through the fabric.

16. The organizational device of claim 13, wherein the writable member includes a base layer that is laminated with the oriented polypropylene, and the label portion comprises a semi-rigid stiffening member disposed beneath the writable member and configured to provide writing support thereto, the welds extending through the stiffening member.

17. The organizational device of claim 13, wherein the frame portion extends around axial sides of the elastic band from the outer portion to the inner portion.

18. The organizational device of claim 13, wherein the writable member includes a paper layer that is laminated with the oriented polypropylene to provide the writing surface.

19. The organizational device of claim 13, wherein the band has a circumference and elasticity selected to hold a stack of index cards.

20. The organizational device of claim 13, wherein welds surround the circumference of the retaining frame, and the welds that affix the retaining frame to the band extend along the axial side of the retaining frame.
